(19) United States
(12) Patent Application Publication
(10) Pub. No.: US 2012/0050440 A1
(43) Pub. Date: Mar. 1, 2012

(54) INKJET RECORDING MEDIUM

(75) Inventor: Ryoichi NAKANO, Kanagawa (JP)

(73) Assignee: FUJIFILM CORPORATION, Tokyo (JP)

(21) Appl. No.: 13/186,478

(22) Filed: Jul. 20, 2011

(30) Foreign Application Priority Data
Aug. 31, 2010 (JP) 2010-195207

(51) Int. Cl. B41J 3/407

(52) U.S. Cl. 347/106

(57) ABSTRACT

The invention provides an inkjet recording medium including a support which includes a base paper and a polyolefin resin layer provided on each side of the base paper, an ink receiving layer that is provided on a side of the support, the ink receiving layer including inorganic particles and a water-soluble resin, and a back layer that is provided on an opposite side of the support to the side on which the ink receiving layer is disposed, the back layer including starch particles.

### CROSS-REFERENCE TO RELATED APPLICATION

This application is based on and claims priority under 35 USC 119 from Japanese patent Application No. 2010-195207 filed on Aug. 31, 2010, the disclosure of which is incorporated by reference herein.

### BACKGROUND

1. Field of the Invention

The present invention relates to an inkjet recording medium.

2. Related Art

In recent years, various methods have been proposed as methods for recording a color image. In any of the methods, recorded products are requested to have high quality with respect to, for example, image quality, texture and the degree of curl of the recorded medium.

As an inkjet recording method, for example, a method that utilizes an inkjet recording medium having an ink-receiving recording layer having a porous structure is put to practical use. One example thereof is an inkjet recording medium having, on a support, a recording layer containing inorganic pigment particles and water-soluble binder and having high porosity. The inkjet recording medium exhibits excellent quick-drying properties due to its porous structure, and has high gloss, so that photo-like images can be recorded using the inkjet recording medium.

A technique related to the above is a method for cutting and winding an inkjet recording medium, the method including using a slitter device including a surface winding device (which is disclosed in, for example, Japanese Patent Application Laid-Open (JP-A) No. 2002-265106). It is disclosed that a decrease in the gloss of the ink receiving layer can be suppressed by decreasing the pressing pressure of a rider roll.

Further, inkjet recording media in which a back coat layer (back layer) is provided, for various purposes, on a face of a support that is opposite to a side at which a recording layer for receiving ink (ink receiving layer) is provided are known (see, for example, JP-A Nos. 2003-11485 and 2000-296669).

### SUMMARY OF THE INVENTION

The present invention has been made in view of the foregoing, and provides an inkjet recording medium. Aspects of the invention include the following.

<1> An inkjet recording medium comprising:

a support which includes a base paper and a polyolefin resin layer provided on each side of the base paper;

an ink receiving layer that is provided on a side of the support, the ink receiving layer comprising inorganic particles and a water-soluble resin; and

a back layer that is provided on an opposite side of the support to the side on which the ink receiving layer is disposed, the back layer comprising starch particles.

<2> The inkjet recording medium according to <1>, wherein the starch particles have a number average particle diameter of from 1 μm to 30 μm.
<3> The inkjet recording medium according to <1> or <2>, wherein a content of the starch particles in the back layer is from 0.1 g/m² to 2 g/m².
<4> The inkjet recording medium according to any one of <1> to <3>, wherein the back layer further comprises a resin.
<5> The inkjet recording medium according to any one of <1> to <4>, wherein the polyolefin resin layer is a polyethylene resin layer.
<6> The inkjet recording medium according to any one of <1> to <5>, wherein a thickness of the polyolefin resin layer is from 10 to 50 μm.
<7> The inkjet recording medium according to any one of <1> to <6>, wherein a content ratio of the starch particles in the back layer is 20% by mass or higher.
<8> The inkjet recording medium according to any one of <4> to <7>, wherein the resin contained in the back layer includes a water-insoluble resin having a number average molecular weight of from 300 to 1,000,000.
<9> The inkjet recording according to <8>, wherein a glass transition temperature (Tg) of the water-insoluble resin is from −10 to 50° C.
<10> The inkjet recording medium according to <8> or <9>, wherein the water-insoluble resin includes at least one of a urethane resin, an acrylic silicone resin, an acrylic styrene resin, a styrene-isoprene resin, or a styrene-butadiene resin.
<11> The inkjet recording medium according to any one of <8> to <10>, wherein a content of the water-insoluble resin in the back layer is from 0.01 g/m² to 0.4 g/m².
<12> The inkjet recording medium according to any one of <8> to <11>, wherein a mass ratio of the starch particles to the water-insoluble resin in the back layer is in a range of from 0.1 to 1.0.
<13> The inkjet recording medium according to any one of <1> to <12>, wherein the inorganic particles are silica particles.
<14> The inkjet recording medium according to any one of <1> to <13>, wherein an average primary particle diameter of the inorganic particles is 20 nm or less.
<15> The inkjet recording medium according to any one of <1> to <14>, wherein the water-soluble resin comprises polyvinyl alcohol.

### BRIEF DESCRIPTION OF THE DRAWINGS

FIG. 1 is a schematic diagram showing an example of the configuration of a surface winding device.

### DETAILED DESCRIPTION OF THE INVENTION

Hereinafter, an exemplary embodiment of the invention will be described with reference to the attached drawing.

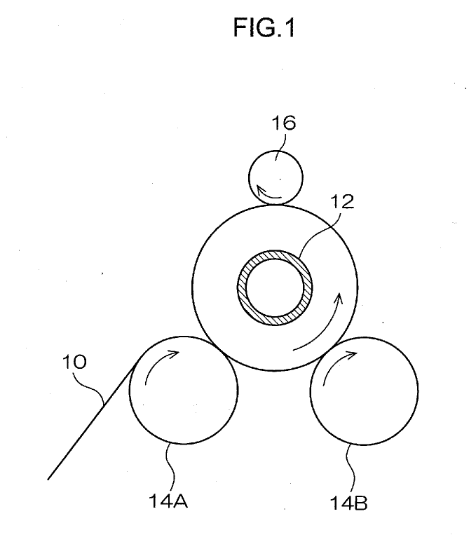

FIG. 1 schematically shows an example of the configuration of a surface winding device. In the surface winding device, driving rollers 14A and 14B and a pressing roller 16 are arranged around a winding core 12 around which an inkjet recording medium 10 is to be wound. Each of the rollers 14A, 14B and 16 rotates in a state in which the rollers press against a surface of the inkjet recording medium wound around the winding core 12. The rotations of the rollers cause the inkjet recording medium 10, which is wound onto the winding core 12, to rotate, as a result of which the inkjet recording medium 10 is sequentially wound.

The present invention has been made based on the following finding. In the case of producing an inkjet recording medium in which polyolefin layers are provided on respective sides of a base paper in order to inhibit curling under high humidity, and in which an ink receiving layer is further provided on the polyolefin layer on one side, use of a surface winding device for winding may, for example, cause mutually-overlapping portions of the wound inkjet recording medium to rub against each other due to the pressure applied by the pressing roller 16, and thus cause the polyolefin resin of the polyolefin layer of the newly wound portion of the inkjet recording medium to adhere to the surface of the ink receiving layer of an already-would portion of the recording medium, as a result of which fog-like unevenness may occur in the ink receiving layer.

Further, in a case in which the coating speed for the formation of the ink receiving layer is increased, or the winding length to be wound around the winding core is increased in order to improve productivity, the pressure applied by the pressing roller 16 needs to be increased so as to prevent deviation of winding. However, an increase in the pressure applied by the pressing roller 16 makes it more likely that an imprint generated by the applied pressure becomes fog-like unevenness in the ink receiving layer.

The inventor of the invention conducted an investigation on a method for preventing the fog-like unevenness caused by the adhesion of a polyolefin resin and the fog-like unevenness caused by the imprint, and, as a result, the inventor has found that the occurrence of the fog-like unevenness can be effectively prevented by including starch particles in a back layer.

<Inkjet Recording Medium>

The inkjet recording medium according to the invention includes:

a support which includes a base paper and a polyolefin layer disposed on each side of the base paper,

an ink receiving layer which is provided on a side of the support, and which includes inorganic particles and a water-soluble resin, and

a back layer which is provided on an opposite side of the support to the side on which the ink receiving layer is disposed, the back layer including starch particles.

In other words, the inkjet recording medium according to the invention includes:

a support which includes a base paper, a first polyolefin layer disposed on one side of the base paper, and a second polyolefin layer disposed on the other side of the base paper,

an ink receiving layer which is provided on one side of the support, and which includes inorganic particles and a water-soluble resin, and

a back layer which is provided on the other side of the support, and which includes starch particles.

The inkjet recording medium having the configuration described above has a lower tendency to curl under high humidity due to the polyolefin resin layers provided on the respective sides, and, when such an inkjet recording medium is used, the occurrence of fog-like unevenness caused by adhesion of a polyolefin resin and the occurrence of fog-like unevenness caused by an imprint generated by an applied pressure during processing with a surface winding device can be prevented.

As used herein, the fog-like unevenness caused by adhesion of a polyolefin resin refers to the state in which surface gloss is uneven—particularly, the state in which surface gloss unevenness is visually observable in an image formed on an ink receiving layer—after the ink receiving layer-side surface and the back layer-side surface are contacted with each other, and are rubbed against each other. It is thought that the generation of this type of gloss unevenness is caused by, for example, mutual rubbing due to positional deviation of the upper surface (ink receiving layer) of one portion of the inkjet recording medium and the lower surface of another portion of the inkjet recording medium overlapping the one portion, and the resultant adhesion of the polyolefin resin to the surface of the ink receiving layer during processing with a surface winding device at a reduced pressing pressure.

Further, the fog-like unevenness caused by an imprint generated by applied pressure refers to the state in which gloss unevenness is visually observable in an image formed on the ink receiving layer after the ink receiving layer-side surface and the back layer-side surface are contacted with each other, and pressure is applied thereto. It is thought that the generation of this type of gloss unevenness is caused by, for example, generation of depressed portions on the surface of the ink receiving layer by strong pressure due to the presence of protruding portions on the back surface of the ink receiving layer, during processing with a surface winding device at an increased pressing pressure.

The reasons why the generation of the fog-like unevenness caused by adhesion of a polyolefin resin and the fog-like unevenness caused by an imprint generated by applied pressure during processing with a surface winding device are suppressed by the configuration according to the invention is presumed to be as follows. Specifically, it is presumed that, since the back layer (back coat layer) including starch particles and provided on the polyolefin layer at a side opposite to the ink receiving layer-side has high hardness, rubbing against the ink receiving layer is suppressed, and adhesion of a resin to the ink receiving layer is suppressed, whereby the fog-like unevenness caused by adhesion of a polyolefin resin can be suppressed; further, since the starch particles exposed on the surface of the back layer serve as spacers, the fog-like unevenness caused by an imprint generated by applied pressure can be suppressed.

(Support)

The support includes a base paper, a first polyolefin resin layer provided on one side of the base paper, and a second polyolefin resin layer provided on the other side of the base paper. The support has excellent glossiness and excellent water resistance due to the inclusion of the polyolefin resin layers.

Specifically, the water resistance in terms of a Cobb sizing water absorbency is preferably 5 g/cm² or less, more preferably 2 g/cm² or less, and still more preferably 1 g/cm² or less. The Cobb sizing water absorbency of a sample is a value determined by measuring the amount of absorbed water when the sample is contacted with pure water for 30 seconds according to JIS (Japanese Industrial Standards) P 8140, the disclosure of which is incorporated by reference herein.

Base Paper

The base paper for use in the invention may be produced using a wood pulp as a main ingredient, and optionally further using a synthetic pulp such as polypropylene and/or a synthetic fiber such as nylon or polyester, as necessary. Any of LBKP, LBSP, NBKP, NBSP, LDP, NDP, LUKP, or NUKP may be used as the wood pulp. It is preferable to increase the total amount of LBKP, NBSP, LBSP, NDP and LDP, which have high contents of short fibers. The proportion of LBSP and/or LDP is preferably from 10% by mass to 70% by mass.

The pulp is preferably a chemical pulp of which the impurity content is low (such as sulfate pulp or sulfite pulp). A pulp of which whiteness has been improved by bleaching treatment is also useful.

One or more of the following agents may be appropriately added into the base paper as necessary: a sizing agent such as a higher fatty acid or an alkylketene dimer, a white pigment such as calcium carbonate, talc, or titanium oxide, a paper-strength enhancing agent such as starch, polyacrylamide, or polyvinyl alcohol, a fluorescent whitening agent, a moisturizing agent such as polyethylene glycol, a dispersant, a softener such as quaternary ammonium, and the like.

The freeness of the pulp used for paper-making is preferably from 200 mL to 500 mL in terms of C.S.F (Canadian Standard Freeness). Further, concerning the fiber length after beating, the sum of the percentage by mass of the pulp remaining on a 24-mesh screen and the percentage by mass of the pulp remaining on a 42-mesh screen according to JIS P-8207 (which is incorporated herein by reference) is preferably from 30% by mass to 70% by mass. In addition, the percentage by mass of the pulp remaining on a 4-mesh screen is preferably 20% by mass or less.

The basis weight of the base paper is preferably from 30 g/m² to 250 g/m², and more preferably from 50 g/m² to 200 g/m². The thickness of the base paper is preferably from 40 μm to 250 μm. High smoothness may also be rendered to the base paper by subjecting the base paper to calender treatment during or after paper-making. The density of the base paper is generally from 0.7 g/cm³ to 1.2 g/cm³ (according to JIS P8118, which is incorporated herein by reference). The stiffness of the base paper is preferably from 20 g to 200 g under the conditions stipulated in JIS P8125, which is incorporated herein by reference.

A surface sizing agent may be coated on a surface of the base paper, and examples of the sizing agent include the above-described examples of sizing agents that can be added into the base paper. The pH of the base paper as measured by a hot water extraction method stipulated in JIS P-8113 (which is incorporated by reference herein) is preferably from 5 to 9.

Various surface treatments or undercoat treatments may be carried out on one side of the base paper or both sides of the base paper, for the purpose of, for example, improving adhesion to the layer to be disposed thereon. Examples of the surface treatment include patterning treatment, such as gloss surface treatment, fine surface treatment described in JP-A No. 55-26507, matte surface treatment, or silky surface treatment, and activation treatment such as corona discharge treatment, flame treatment, glow discharge treatment, or plasma treatment. Examples of the undercoat treatment include the method described in JP-A No. 61-846443.

Each of these surface treatments may be performed singly, or may be arbitrarily combined with at least one other surface treatment. For example, activation treatment may be performed after performing, for example, patterning treatment; or undercoat treatment may be performed after performing surface treatment such as activation treatment.

Polyolefin Resin Layer The support according to the invention includes a resin layer (polyolefin resin layer) which contains a polyolefin resin (preferably as a main component), and which are provided on each side of the base paper. In other words, the support includes a first polyolefin resin layer provided on one side of the base paper, and a second polyolefin resin layer provided on the other side of the base paper. The specifics, such as composition and thickness, of the first polyolefin resin layer may be the same as or different from the specifics, such as composition and thickness, of the second polyolefin resin layer. The specifics of the polyolefin resin layer described below are applicable to both of the first and second polyolefin resin layers.

Examples of the polyolefin resin used in the polyolefin resin layer include polyethylene and polypropylene. The polyethylene to be used may be high density polyethylene (HDPE), low density polyethylene (LDPE), or linear low density polyethylene (L-LDPE). From the viewpoint of the stiffness of a support for photographic paper, it is preferable to use polypropylene, high density polyethylene (HDPE), or linear low density polyethylene (L-LDPE). The resin may be used alone, or a mixture of two or more thereof may be used.

Here, high density polyethylene and low density polyethylene are defined in JIS K6748: 1995, which is incorporated herein by reference. High density polyethylene is a polyethylene having a density of 0.942 g/cm³ or higher, and low density polyethylene is a polyethylene having a density of from 0.910 g/cm³ to 0.930 g/cm³. Linear low density polyethylene is a polyethylene defined in JIS K6899-1: 2000, which is incorporated herein by reference.

The polyolefin resin layer may be formed using low density polyethylene. In view of improving thermal resistance of the support, it is preferable to use polypropylene, a blend of polypropylene and polyethylene, high density polyethylene, or a blend of high density polyethylene and low density polyethylene. From the viewpoints of, for example, costs and suitability for lamination, it is most preferable to use a blend of high density polyethylene and low density polyethylene.

The blend of high density polyethylene and low density polyethylene may have a blend ratio (high density polyethylene/low density polyethylene in terms of mass ratio) in the range of, for example, from 1/9 to 9/1, preferably from 2/8 to 8/2, and more preferably from 3/7 to 7/3.

The molecular weight of polyethylene is not particularly limited. The high density polyethylene preferably has a melt index (defined in JIS K7210, which is incorporated herein by reference) of from 1.0 g/10 min to 40 g/10 min, and preferably has suitability for extrusion. The low density polyethylene preferably has a melt index (defined in JIS K7210, which is incorporated herein by reference) of from 1.0 g/10 min to 40 g/10 min, and preferably has suitability for extrusion.

The method of forming the polyolefin resin layer on each side of the base paper is not particularly limited, and may be suitably selected depending on the purpose. For example, the polyolefin resin layer may be formed by any of the following (i) to (iv): (i) dry-laminating (adhering) a polyolefin film onto the base paper, (ii) coating a polyolefin resin on the base paper using a solvent, (iii) coating a polyolefin resin on the base paper using a polyolefin emulsion in an aqueous medium, (iv) impregnating the base paper with a polyolefin emulsion, or (v) coating a polyolefin resin on the base paper by melt extrusion. From the points of productivity, the polyolefin resin layer is preferably formed by melt-extrusion coating.

The thickness of the polyolefin resin layer is not particularly limited. From the viewpoints of smoothness and water resistance, the thickness of the polyolefin resin layer is preferably from 1 μm to 50 μm, more preferably from 10 μm to 50 μm

Here, the thickness of the polyolefin resin layer is a value obtained by cutting the polyolefin resin layer using a microtome (trade name: MICROTOME RM2165, manufactured by LEICA) to form a slice, and measuring the thickness of the slice using an optical microscope (trade name, OPTICAL MICROSCOPE BX-60, manufactured by OLYMPUS CORPORATION).

The surface roughness (SRa) of the polyolefin resin layer is not particularly limited. The surface roughness (SRa) of the polyolefin resin layer with a frequency of from 0.2 mm to 0.3 mm is preferably from 0.02 μm to 0.20 μm, from the viewpoints of image clarity, smoothness, and surface defects of the image recording layer. When the SRa is from 0.02 μm to 0.20 μm, image clarity and smoothness of the recording medium improves, and surface defects of the recording medium tend to be suppressed, which is preferable.

The surface roughness of the polyolefin resin layer described above means a value obtained by measurement with a NEW VIEW 5022 (trade name, manufactured by Zygo KK).

The polyolefin resin layer preferably includes a white pigment or a fluorescent whitening agent, as necessary, in addition to the polyolefin resin.

The fluorescent whitening agent is a compound that has absorption in the near ultraviolet region and emits fluorescence at an emission wavelength of from 400 nm to 500 nm. Known fluorescent whitening agents may be used without particular limitations. Preferable examples of the fluorescent whitening agent include the compounds described in K. VeenRataraman ed., The Chemistry of Synthetic Dyes, vol. V, chap. 8. Specific examples of the fluorescent whitening agent include a stilbene compound, a coumalin compound, a biphenyl compound, a benzoxazoline compound, a naphthalimide compound, a pyrazoline compound, and a carbostyril compound. More specific examples thereof include WHITE FULFAR PSN, PHR, HCS, PCS, and B (trade names, all manufactured by Sumitomo Chemical Co., Ltd.), and UVITEX-OB (trade name, manufactured by Ciba-Geigy Co., Ltd.).

Examples of the white pigment include titanium oxide, calcium carbonate, barium sulfate, and zinc oxide. Among these, titanium oxide is preferable from the point of shielding properties.

The content of the white pigment or the fluorescent whitening agent in the polyolefin resin layer is preferably from 0.1 g/m² to 8 g/m², and more preferably from 0.5 g/m² to 5 g/m². When the content is larger than 0.1 g/m², light transmittance of the support may become high. When the content exceeds 8 g/m², cracking of the surface of the support may occur, and handling properties such as adhesion resistance may deteriorate.

(Back Layer)

The inkjet recording medium according to the invention includes a back layer that includes starch particles, and that is provided on a side (hereinafter also referred to as “back side”) of the support opposite to a side on which the ink receiving layer is disposed.

—Starch Particles—

Examples of the starch particles contained in the back layer include: particles containing an oxidized starch, an acetylated starch, a hydroxyethylated starch, an etherified starch, an esterified starch, an enzymatically-modified starch, or a thermochemically-modified starch, each of which is obtained by modifying a row material such as corn, potato, tapioca, or wheat; and particles containing dextrin. Examples of commercially available starch particles include HAMANOYUKI (trade name, manufactured by SHIN-SHIN FOODS Co., LTD.), RICE STARCH (manufactured by JAPAN CORN STARCH Co., LTD.), FINE SNOW (trade name, manufactured by JOETSU STARCH Co., LTD.), and BKK-401 (trade name, manufactured by BANGKOK STARCH INDUSTRIAL CO., LTD.).

The number average particle diameter of the starch particles contained in the back layer is preferably from 1 μm to 30 μm, and more preferably from 2 μm to 20 μm. A number average particle diameter of the starch particles of 1 μm or more effectively suppresses an imprint generated by applied pressure, and a number average particle diameter of 30 μm or less is preferable from the viewpoints of sedimentation properties and coating suitability of the coating liquid for forming the back layer.

The number average particle diameter as used herein refers to the number average particle diameter of the particles observed with a scanning electron microscope (SEM).

In the invention, the content of starch particles in the back layer is preferably from 0.1 g/m² to 2 g/m², and more preferably from 0.15 g/m² to 1 g/m². When the content of starch particles is 0.1 g/m² or more, fog-like unevenness caused by adhesion of a polyolefin resin and fog-like unevenness caused by an imprint generated by applied pressure are effectively suppressed. A content of starch particles of 2 g/m² or less is preferable from the viewpoint of reduction of coating and drying load in the formation of the back layer.

Further, the content ratio of starch particles contained in the back layer is preferably 20% by mass or higher, more preferably 50% by mass or higher, and still more preferably 60% by mass or higher, with respect to the total solids content of the back layer.

—Resin—

The back layer preferably includes a resin as a binder for retaining the starch particles, in addition to the starch particles. The resin is preferably a water-insoluble resin. The water-insoluble resin is not particularly limited with respect to the type thereof, and known water-dispersible resins may be used. One water-dispersible resin may be used singly, or two or more thereof may be used in mixture. Further, a resin that is known as a water-dispersion-type latex is suitable for use as the water-insoluble resin.

Further, the water-dispersion-type latex may further include one or more components, other than the water-insoluble resin, which can be added to the water-dispersion-type latex. The components which can be added to the water-dispersion-type latex may be selected, without particular limitation, from known components that can be used with the water-insoluble resin.

The water-dispersion-type latex is a dispersion in which a hydrophobic polymer that is insoluble or scarcely soluble in water is dispersed, in the form of fine particles, in an aqueous dispersion medium. The dispersion state thereof may be any of a state in which the polymer is emulsified in the dispersion medium, a state in which the polymer is formed by emulsion polymerization, a state in which the polymer in the form of micelles are dispersed, or a state in which the molecular chain of the polymer itself is molecular-dispersed due to hydrophilic structures that the polymer has at portions of a molecule thereof. Such water-dispersion-type latexes are described in detail in, for example, Taira Okuda & Hiroshi Inagaki ed., Gosei Jushi Emulsion, (Kobunshi Kankokai, 1978); Takaaki Sugimura, Yasuo Kataoka, Sohichi Suzuki & Keiji Kasahara ed., Gosei Latex no Ouyou, (Kobunshi Kankokai, 1993); and Sohichi Muroi, Gosei Latex no Kagaku, (Kobunshi Kankokai, 1970).

Specific examples of the latex include latexes of thermoplastic resins such as an acrylic latex, an acrylic silicone latex, an acrylic-epoxy latex, an acrylic-styrene latex, an acrylic-urethane latex, a styrene-butadiene latex, a styrene-isoprene latex, an acrylonitrile-butadiene latex, a polyester-urethane latex, and a vinyl acetate latex.

With a view to suppressing fog-like unevenness and improving conveyance properties and accumulation properties of the recording medium, the latex is preferably composed of at least one selected from a urethane latex (such as an acrylic-urethane latex or a polyester-urethane latex), an acrylic silicone latex, an acrylic styrene latex, a styrene-isoprene latex, or a styrene-butadiene latex, and is more preferably composed of at least one selected from a urethane latex, a styrene-isoprene latex, or a styrene-butadiene latex.

The number average molecular weight of the water-insoluble resin in the latex is preferably from 300 to 1,000,000, and more preferably from about 500 to about 100,000. When the water-insoluble resin has a number-average molecular weight of 300 or more, fog-like unevenness can be more effectively suppressed. A number-average molecular weight of the water-insoluble resin of 1,000,000 or less is preferred from the viewpoints of suitability for production, such as the dispersion stability and the viscosity of a coating liquid for forming the back layer.

The latex may be a commercially available product. For example, water-dispersion-type latexes such as those described below may be used. Examples of acrylic latexes include acrylic resin latexes such as CEVIAN A4635, 46583 and 4601 (trade names, manufactured by DAICEL CHEMICAL INDUSTRIES, LTD.) and NIPOL LX 811, 814, 821, 820 and 857 (trade names, manufactured by ZEON CORPORATION); and acrylic emulsions of acrylic silicone latexes such as those disclosed in JP-A Nos. 10-264511, 2000-43409, 2000-343811 and 2002-120452, of which commercially available products include AQUABRID series UM7760, UM7611 and UM4901, and AQUABRID 903, AQUABRID 46704, AQUABRID ASi-86, AQUABRID ASi-89, AQUABRID ASi-91, AQUABRID ASi-753, AQUABRID 4635, AQUABRID 4901, AQUABRID MSi-045, AQUABRID AU-124, AQUABRID AU-131, AQUABRID AEA-61, AQUABRID AEC-69 and AQUABRID AEC-162 (trade names, manufactured by manufactured by DAICEL CHEMICAL INDUSTRIES, LTD.).

Examples of commercially available products of polyester-urethane latexes include HYDRAN AP series (for example, HYDRAN AP-20, HYDRAN AP-30, HYDRAN AP-30F, HYDRAN AP-40(F), HYDRAN AP-50LM, AP-60LM, HYDRAN APX-101H, HYDRAN APX-110 and HYDRAN APX-501 (trade names) manufactured by DIC CORPORATION.

Examples of commercially available products of styrene-isoprene latexes include LACSTAR 7310K, 3307B, 4700H, and 7132C (trade names) manufactured by DIC CORPORATION, NIPOL LX416, LX410, LX430, LX435, LX110, LX415A, LX438C, 2507H, LX303A, LX407BP series, V1004, and MHSO55 (trade names, manufactured by ZEON CORPORATION).

In regard to the latex, it is preferable to use at least one selected from those listed above. The latex may be used singly, or in mixture of two or more thereof.

The glass transition temperature (Tg) of the water-insoluble resin may be preferably from −20° C. to 70° C., and particularly preferably from −10° C. to 50° C. When the Tg is within the foregoing range, occurrence of fog-like unevenness can be more effectively suppressed, and the conveyance properties and accumulation properties of the recording medium also improve.

The water-insoluble resin (preferably a water-dispersion-type latex) preferably has a minimum film-formation temperature (MFT) of from −20° C. to 50° C., and more preferably from −10° C. to 40° C.

When the MFT is within the foregoing range, occurrence of fog-like unevenness can be more effectively suppressed, and the conveyance properties and accumulation properties of the recording medium also improve.

In the invention, the coating amount of the water-insoluble resin for forming the back layer is preferably from 0.01 g/m² to 0.4 g/m², and more preferably from 0.02 g/m² to 0.3 g/m², in terms of solids amount. When the coating amount of the water-insoluble resin is from 0.01 g/m² to 0.4 g/m², occurrence of fog-like unevenness is more effectively suppressed.

In the invention, the ratio by mass of the content of starch particles to the content of water-insoluble resin (starch particles/water-insoluble resin) in the back layer may be in the range of from 0.05 to 1.2. From the viewpoints of suppressing fog-like unevenness and improving the conveyance properties and accumulation properties of the recording medium, the ratio by mass of the content of starch particles to the content of water-insoluble resin (starch particles/water-insoluble resin) in the back layer is preferably in the range of from 0.1 to 1.0, and more preferably in the range of from 0.2 to 0.9.

—Other Components—

The back layer may include an organic pigment. Examples of the organic pigment include styrenic plastic pigments, acrylic plastic pigments, polyethylene, microcapsules, urea resins, and melamine resins.

The back layer may further include an additive such as an aqueous binder, an oxidation inhibitor, a surfactant, a defoaming agent, an anti-foaming agent, a pH adjuster, a curing agent, a coloring agent, a fluorescent whitening agent, an antiseptic agent, or a water-resistant additive.

Examples of the aqueous binder include water-soluble polymers such as a styrene-maleate copolymer, a styrene-acrylate copolymer, polyvinyl alcohol, silanol-modified polyvinyl alcohol, starch, cationized starch, casein, gelatin, carboxymethyl cellulose, hydroxyethyl cellulose, and polyvinylpyrrolidone; and water-dispersible polymers such as a styrene-butadiene latex and an acrylic emulsion.

In the invention, the solids application amount of the back layer may be from 0.05 g/m² to 0.5 g/m². The solids application amount of the back layer is preferably from 0.1 g/m² to 0.4 g/m² from the viewpoint of improving the conveyance properties and accumulation properties of the recording medium as well as the suppressing fog-like unevenness.

The solids application amount of the back layer as used herein refers to the total application amount (mass) of the components of the back layer other than water. In a case in which the back layer is formed by coating, the solids application amount of the back layer refers to the total coating amount of the components, other than water, contained in the coating liquid for forming the back layer.

The back layer in the invention preferably includes at least one water-insoluble resin selected from a urethane latex, an acrylic silicone latex, an acrylic styrene latex, a styrene-isoprene latex, or a styrene-butadiene latex such that the ratio by mass of the content of starch particles to the content of the water-insoluble resin is in the range of from 0.5 to 12, and the solids application amount of the back layer is preferably from 0.1 g/m² to 2 g/m², from the viewpoint of improving the conveyance properties and accumulation properties of the recording medium as well as suppressing fog-like unevenness.

The method of forming the back layer in the invention is not particularly limited. The back layer may be formed by using a generally-employed layer-forming method such as a coating method.

Specifically, the back layer may be formed by applying a coating liquid for forming a back layer onto a side of the support opposite to the ink receiving layer side such that a desired solids application amount of the coating liquid for forming a back layer is obtained, and drying the coating liquid applied. Here, the coating liquid for forming a back layer includes starch particles and a water-insoluble resin (preferably, a water-dispersion-type latex), and optionally further includes one or more other components.

The application of the coating liquid for forming a back layer may be conducted according to a known coating method. Specifically, the application can be conducted in the same manner as the below-described method for applying the coating liquid for forming an ink receiving layer.

The drying conditions may be selected, as appropriate, in accordance with the coating amount, and the drying may be carried out, for example, at from 40° C. to 180° C. for from 0.5 minutes to 10 minutes.

(Ink Receiving Layer)

In the inkjet recording medium according to the invention, an ink receiving layer that includes at least one kind of inorganic particles and at least one water-soluble resin, and optionally further includes one or more other components, is provided on a side of the support (opposite to the back layer side).

—Inorganic Particles—

Examples of the inorganic particles include silica particles, colloidal silica, titanium dioxide particles, barium sulfate particles, calcium silicate particles, zeolite particles, kaolinite particles, halloysite particles, mica particles, talc particles, calcium carbonate particles, magnesium carbonate particles, calcium sulfate particles, boehmite particles, and pseudoboehmite particles. Among these, silica particles are preferable.

Silica particles are advantageous in that silica particles have high efficiency with respect to absorption and retention of ink due to their particularly high specific surface area, and in that the silica particles, having a low refractive index, can impart transparency to the ink receiving layer when dispersed to have an appropriate microparticle diameter, and can provide high color density and excellent color properties. The transparency of the ink receiving layer is important from the viewpoints of obtaining high color density, excellent color properties, and excellent glossiness when applied to recording sheets such as photo gloss paper.

The average primary particle diameter of the inorganic particles is preferably 20 nm or less, more preferably 15 nm or less, and particularly preferably 10 nm or less. When the average primary particle diameter is 20 nm or less, ink absorption characteristics effectively improve, and the glossiness of the surface of the ink receiving layer heightens.

The specific surface area of the inorganic particles as determined by the BET method is preferably 200 m²/g or higher, and more preferably 250 m²/g or higher. When the specific surface area of the inorganic particles is 200 m²/g or higher, the ink receiving layer has high transparency, and a high image density of a printed image can be obtained.

The BET method in the invention is a method of measuring a surface area of powder using a vapor-phase adsorption method. In the BET method, the specific surface area, which is the total surface area per 1 g of a specimen, is obtained from an adsorption isotherm. In the BET method, nitrogen gas is often used as a gas to be adsorbed, and the adsorption amount is most commonly determined from a change in the pressure or volume of the adsorbed gas. An equation proposed by Brunauer, Emmett, and Teller, which is called a BET equation, is the most famous equation representing an isotherm of multimolecular adsorption. The BET equation is widely used for determining the surface area. An adsorption amount determined based on the BET equation is multiplied by a surface area occupied by one adsorbed molecule, whereby the surface area of the powder is determined.

Silica particles have silanol groups on surfaces thereof. Therefore, the silica particles have a tendency to adhere to one another due to hydrogen bonding of the silanol groups. Further, an interaction between the water-soluble resin and the silanol groups also exerts effects that promote adhesion between silica particles. Hence, when the average primary particle diameter of silica particles is 20 nm or less as described above, the ink receiving layer may have a structure having high porosity and high transparency, and the ink receiving layer may have effectively-improved ink absorption characteristics.

The inorganic particles most preferably used in the invention may be fumed silica having a specific surface area of 200 m²/g or more as determined by the BET method.

—Water-Soluble Resin—

Examples of the water-soluble resin include polyvinyl alcohol resins having a hydroxyl group as a hydrophilic group (for example, polyvinyl alcohol (PVA), acetoacetyl-modified polyvinyl alcohol, cation-modified polyvinyl alcohol, anion-modified polyvinyl alcohol, silanol-modified polyvinyl alcohol, and polyvinyl acetal), cellulose resins (for example, methyl cellulose (MC), ethyl cellulose (EC), hydroxyethyl cellulose (HEC), carboxymethyl cellulose (CMC), hydroxypropyl cellulose (HPC), hydroxyethyl methyl cellulose, and hydroxypropyl methyl cellulose), chitins, chitosans, starches, resins having an ether bond (for example, polyethylene oxide (PEO), polypropylene oxide (PPO), and polyvinyl ether (PVE)), and resins having a carbamoyl group (for example, polyacrylamide (PAAM), polyvinyl pyrrolidone (PVP), and polyacrylic acid hydrazide).

Examples of the water-soluble resin further include polyacrylic acid, maleic acid resins, alginic acid, and gelatins, each of which has a carboxyl group and/or a salt thereof as a dissociative group.

Among the above resins, polyvinyl alcohol resins are particularly preferable. Examples of polyvinyl alcohol resins include those described in Japanese Patent Publication (JP-B) Nos. 4-52786, 5-67432 and 7-29479, Japanese Patent No. 2537827, JP-B No. 7-57553, Japanese Patent Nos. 2502998 and 3053231, JP-A No. 63-176173, Japanese Patent No. 2604367, JP-A Nos. 7-276787, 9-207425, 11-58941, 2000-135858, 2001-205924, 2001-287444, 62-278080 and 9-39373, Japanese Patent No. 2750433, and JP-A Nos. 2000-158801, 2001-213045, 2001-328345, 8-324105 and 11-348417.

Further, examples of water-soluble resins other than polyvinyl alcohol resins include the compounds described in paragraphs [0011] to [0014] of JP-A No. 11-165461.

The water-soluble resin may be used singly, or two or more thereof may be used in combination.

The content of the water-soluble resin used in the invention is preferably from 9% by mass to 40% by mass, and more preferably from 12% by mass to 33% by mass, relative to the total solids content of the ink receiving layer.

The inorganic particles and the water-soluble resin are main components of the ink receiving layer. The inorganic particles may be composed of a single material or may be a mixture of plural materials. The water-soluble resin may be composed of a single material or may be a mixture of plural materials.

The kind of water-soluble resin used in combination with the inorganic particles is important from the viewpoint of improving the image density of a print image while maintaining transparency. The water-soluble resin is preferably a polyvinyl alcohol resin, more preferably a polyvinyl alcohol resin having a saponification degree of from 70% to 100%, and further preferably a polyvinyl alcohol resin having a saponification degree of from 80% to 99.5%.

A polyvinyl alcohol resin may be used together with a water-soluble resin other than the polyvinyl alcohol resin. In a case in which the polyvinyl alcohol resin is used together with another water-soluble resin, the content of the polyvinyl alcohol resin is preferably 50% by mass or higher, and more preferably 70% by mass or higher, relative to the total content of water-soluble resins in the image receiving layer.

Content Ratio of Inorganic Particles to Water-soluble Resin

The content ratio by mass (PB ratio (x/y)) of the inorganic particles (x) to the water-soluble resin (y) largely affects the film structure and the film strength of the ink receiving layer. In other words, there is a tendency that a higher content ratio by mass (PB ratio) leads to a higher porosity, a higher pore volume, and a larger surface area (per unit mass) but also leads to decreased density and decreased strength.

The content ratio by mass (PB ratio (x/y)) in the ink receiving layer in the invention is preferably from 1.5:1 to 10:1, from the viewpoints of preventing a decrease in film strength and generation of cracks during drying, which result from excessively high PB ratios, and preventing a reduction in porosity and ink absorbency caused by an increased tendency for pores to be clogged by the resins, which, in turn, results from excessively low PB ratios.

When passing through a conveyance system of an image recording apparatus, the recording medium may sometimes receive stress. Therefore, the ink receiving layer should have sufficient film strength. Moreover, the sufficient film strength of the ink receiving layer is desired also from the viewpoint of suppressing cracking, detachment, or the like of the ink receiving layer when the recording medium is cut into sheets. In view of the above, the content ratio by mass (x/y) is preferably 5/1 or lower, and, from the viewpoint of providing ability to rapidly absorb ink when the recording medium is used in an inkjet printer, the content ratio by mass (x/y) is preferably 2/1 or higher.

For example, a light-transmitting porous film having a three-dimensional network structure having secondary particles of the silica particles as the network chains can be easily formed by completely dispersing fumed silica having an average primary particle diameter of 20 nm or less (x) and a water-soluble resin (y) in an aqueous solution at a content ratio by mass (x/y) of from 2/1 to 5/1, applying the resultant solution onto the support, and then drying the resultant coating layer. The resultant porous film may have an average pore diameter of 30 nm or less, a porosity of from 50% to 80%, a specific pore volume of 0.5 mL/g or more, and a specific surface area of 100 m²/g or higher.

—Other Components—

The ink receiving layer in the invention may further include other components such as various known additives, as necessary. Examples of the additives include crosslinking agents, acids, ultraviolet absorbers, antioxidants, fluorescent whitening agents, monomers, polymerization initiators, polymerization inhibitors, bleed inhibitors, antiseptics, viscosity stabilizers, defoaming agents, surfactants, antistatic agents, matt agents, curl inhibitors, water-resistant additives, and anti-fading agents such as singlet oxygen quenchers. Inclusion of these additives suppresses deterioration of the ink.

Other components may be selected, as appropriate, from the ingredients described in paragraphs [0101] to [0117] of JP-A No. 2005-14593, the ingredients described in paragraphs [0149] to [0155] of JP-A No. 2006-321176, and the like.

A preferable crosslinking agent for crosslinking the water-soluble resin—especially, polyvinyl alcohol—is a boron compound. Specific examples thereof include borax, boric acid, borates (such as orthoborates, InBO₃, ScBO₃, YBO₃, LaBO₃, Mg₃(BO₃)₂ and CO₃(BO₃)₂), diborates (such as Mg₂B₂O₅ and CO₂B₂O₅), metaborates (such as LiBO₂, Ca(BO₂)₂, NaBO₂, and KBO₂), tetraborates (such as Na₂B₄O₇.10H₂O), pentaborates (such as KB₅O₈.4H₂O and CsB₅O₅) and hexaborates (such as Ca₂B₆O₁₁.7H₂O). Among these, borax, boric acid, and borates are preferable, and boric acid is particularly preferable, from the viewpoint of rapidness of crosslinking reaction.

In the ink receiving layer, the amount of crosslinking agent to be used is preferably from 1% by mass to 50% by mass, and more preferably from 5% by mass to 40% by mass, relative to the water-soluble resin.

Mordant

The ink receiving layer preferably includes at least one mordant in order to improve water resistance and to ameliorate bleeding over time of a formed image.

Preferable examples of mordants include organic mordants such as cationic polymers (cationic mordants) and inorganic mordants such as water-soluble metal compounds. Examples of the cationic mordants preferably include polymeric mordants having a primary amino group, a secondary amino group, a tertiary amino group or a quarernary ammonium base as a cationic functional group, and further include cationic non-polymeric mordants.

Preferable examples of the polymeric mordants include a homopolymer of a monomer having a primary, secondary, or tertiary amino group or a salt thereof or a quarernary ammonium base (mordant monomer), and a copolymer or condensed polymer of at least one mordant monomer and at least one other monomer (non-mordant monomer). Further, the polymeric mordant may be used either in the form of a water-soluble polymer or in the form of water-dispersion-type latex particles.

Specific examples of mordant monomers and cationic polymers include those disclosed in paragraphs [0024] to [0031] of JP-A No. 2008-246988. Specific examples of inorganic mordants include those disclosed in paragraphs [0130] to [0137] of JP-A No. 2008-246988.

The amount of mordant included in the ink receiving layer is preferably from 0.01 g/m² to 5 g/m².

Water-Soluble Aluminum Compound

The ink receiving layer in the invention preferably further includes at least one water-soluble aluminum compound. Inclusion of the water-soluble aluminum compound more effectively improves the water resistance and the bleeding resistance over time of an image obtained.

Examples of the water-soluble aluminum compound include aluminum chloride and hydrates thereof, aluminum sulfate and hydrates thereof, and ammonium alum, which are inorganic salts. Examples of the water-soluble aluminum compound further include a basic polyaluminum hydroxide compound, which is an inorganic aluminum-containing cationic polymer. Among them, a basic polyaluminum hydroxide compound is preferred.

The basic polyaluminum hydroxide compound is a water-soluble polyalumium hydroxide of which the main component is represented by the following formulae 1, 2 or 3, and which stably includes a basic polymeric multinuclear condensation ion such as [Al₆(OH)₁₅]³⁺, [Al₈(OH)₂₀]⁴⁺, [Al₁₃(OH)₃₄]⁵⁺, or [Al₂₁(OH)₆₀]³⁺.

[Al₂(OH)ₙCl₍₆₋ₙ₎]ₘ(5<m<80, 1<n<5) (formula 1)

[Al(OH)₃]ₙAlCl₃(1<n<2) (formula 2)

Alₙ(OH)ₘCl₍₃ₙ₋ₘ₎(0<m<3n, 5<m<8) (formula 3)

These compounds are available from Taki Chemical Co., Ltd. as a water treatment agent with a product name of polyaluminum chloride (PAC), from Asada Chemical Industry Co. Ltd. under the trade name of polyaluminum hydroxide (Paho), from RIKENGREEN CO., LTD. under the trade name of PURACHEM WT, from TAIMEI CHEMICALS Co., Ltd. under the trade name of ALFINE 83, or from other manufacturers as products for similar applications, and products of various grade are easily available. In the invention, these commercially available products can be used as they are. However, when the pH of a commercially available product is unsuitably low, the commercial product may be used after suitably adjusting the pH.

The content of water-soluble aluminum compound in the ink receiving layer in the invention is preferably from 0.1% by mass to 20% by mass, more preferably from 1% by mass to 8% by mass, and most preferably from 2% by mass to 4% by mass, with respect to the total solids content of the ink receiving layer. A content of water-soluble aluminum compound within the above range effectively produces effects with respect to improvement of gloss, water resistance, gas resistance, and light resistance.

Zirconium Compound

It is preferred that the ink-receiving layer in the invention includes at least one zirconium compound. Use of the zirconium compound more effectively exerts effects with respect to improvement of water resistance.

The zirconium compound used in the invention is not particularly limited, and various zirconium compounds can be used. Examples thereof include zirconyl acetate, zirconyl chloride, zirconium oxychloride, zirconyl hydroxychloride, zirconyl nitrate, basic zirconium carbonate, zirconyl hydroxide, ammonium zirconyl carbonate, potassium zirconyl carbonate, zirconyl sulfate, and a zirconyl fluoride compound. Zirconyl acetate is particularly preferred.

The content of zirconium compound in the ink receiving layer in the invention is preferably from 0.05% by mass to 5.0% by mass, more preferably from 0.1% by mass to 3.0% by mass, and particularly preferably from 0.5% by mass to 2.0% by mass, relative to the total solids content of the ink receiving layer. A zirconium compound content within the above range makes it possible to effectively improve water resistance without decreasing ink absorbency.

In the invention, the ink receiving layer may further include a water-soluble polyvalent metal compound that is different from the water-soluble aluminum compound and the zirconium compound described above. Examples of the water-soluble polyvalent metal compound other than the water-soluble aluminum compound and the zirconium compound include a water-soluble salt of a metal selected from calcium, barium, manganese, copper, cobalt, nickel, iron, zinc, chromium, magnesium, tungsten, or molybdenum.

Specific examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, ammonium cupric chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amide sulfate tetrahydrate, ferrous bromide, ferrous chloride, ferric chloride, ferrous sulfate, ferric sulfate, zinc bromide, zinc chloride, zinc nitrate hexahydrate, zinc sulfate, chromium acetate, chromium sulfate, magnesium sulfate, magnesium chloride hexahydrate, magnesium citrate nonahydrate, sodium phosphorus tungstate, sodium tungsten citrate, 12-tungstophosphate n-hydrate, 12-tungstosilicate 26-hydrate, molybdenum chloride, and 12-molybdophosphate n-hydrate.

The thickness of the ink receiving layer should be determined in relation to the porosity of the ink receiving layer since the ink receiving layer should have an absorption capacity sufficient for absorbing all ink droplets in the case of inkjet recording. For example, when the amount of ink is 8 mL/mm² and the porosity is 60%, the thickness of the ink receiving layer is preferably about 15 μm or more. From this viewpoint, the thickness of the ink receiving layer is preferably from 10 μm to 50 μm in the case of inkjet recording.

The porosity of the ink receiving layer can be measured using a mercury porosimeter PORESIZER 9320-PC2 (trade name, manufactured by Shimadzu Corporation).

The ink receiving layer preferably has high transparency. As a general guideline, the haze value of the ink receiving layer formed on a transparent film support is preferably 30% or less, and more preferably 20% or less. The haze value can be measured with a haze meter HGM-2DP (trade name, manufactured by SUGA INSTRUMENTS Co., Ltd.).

The ink receiving layer may be composed of only one layer, or composed of two or more sub-layers. When the ink receiving layer is composed of two or more sub-layers, each of the sub-layers which constitute the ink receiving layer may have a composition different from that of a layer adjacent thereto. Here, different composition refers to, for example, a difference in at least one of the type or content of a component of the sub-layer.

The method of forming an ink receiving layer in the invention is not particularly limited, and an ink receiving layer may be formed by using a general method for forming a layer, such as a coating method.

Specifically, the ink receiving layer may be formed by applying a coating liquid for forming an ink receiving layer, which includes inorganic particles and a water-soluble resin and optionally further includes other components as necessary, onto a side of the support (the side opposite to the back layer side), and drying the liquid applied.

The method of forming an ink receiving layer of an inkjet recording medium of the invention may include:

preparing a dispersion liquid by dispersing inorganic particles and zirconium compound by head-on-collision or passing through an orifice, using a high pressure disperser;

preparing an ink receiving layer formation liquid by adding the cationic polymer, polyvinyl alcohol and cross-linking agent to the dispersion liquid; and

forming a coating layer by applying a coating liquid, which is obtained by in-line mixing of a water-soluble aluminum compound into the ink receiving layer formation liquid, onto the support.

With respect to details on the method of preparing the dispersion liquid, the ink receiving layer formation liquid, and the coating liquid, the method described in paragraphs to [0117] of JP-A No. 2007-223119, for example, can preferably be applied in the invention.

The application of the ink receiving layer formation liquid may be carried out according to a known coating method using, for example, an extrusion die coater, an air doctor coater, a blade coater, a rod coater, a knife coater, a squeeze coater, a reverse roll coater, or a bar coater.

### EXAMPLES

In the following, the invention is described in further detail with reference to examples. However, the examples should not be construed as limiting the invention. The terms “part(s)” and “%” represent “part(s) by mass” and “% by mass”, respectively, unless indicated otherwise.

### Example 1

### Preparation of Support

50 parts of LBKP obtained from acacia and 50 parts of LBKP obtained from aspen were respectively beaten using a disc refiner to give a Canadian freeness of 300 mL, thereby preparing a pulp slurry. Subsequently, to the pulp slurry obtained, 1.3% of cationic starch (trade name: CAT 0304L, manufactured by Nippon NSC, Ltd.), 0.15% of anionic polyacylamide (trade name: POLYACRON ST-13, manufactured by Seiko PMC Corporation), 0.29% of an alkyl ketene dimer (trade name: SIZEPINE K, manufactured by Arakawa Chemical Industries, Ltd.), 0.29% of epoxidated behenic acid amide, and 0.32% of polyamide-polyamine-epichlorohydrin (trade name: ARAFIX 100, manufactured by Arakawa Chemical Industries, Ltd.) were added, and thereafter 0.12% of a defoaming agent was added thereto. The percentages above are percentages relative to the pulp.

The pulp slurry prepared as described above was used for paper making using a Fourdrinier paper machine. The felt face of the web was pressed against a drum dry cylinder with a dryer canvas interposed therebetween at a tensile strength of the dryer canvas set at 1.6 kg/cm, thereby drying the web. Then, polyvinyl alcohol (trade name: KL-118, manufactured by Kuraray Co., Ltd.) was coated on both sides of the base paper in an amount of 1 g/m² by size press, and then dried and calendered. The base paper was formed to have a basis weight of 157 g/m², and thus a base paper (substrate paper) having a thickness of 157 μm was obtained.

The wire face side (back side) of the base paper obtained was subjected to corona discharge treatment. Thereafter, a blend of high density polyethylene (density of 0.95 g/cm³) and low density polyethylene (density of 0.92 g/cm³) at a mass ratio (high density polyethylene/low density polyethylene) of 80%/20% was coated on the wire face (back face) in a coating amount of 20 g/m² by melt extrusion at a temperature of 320° C. using a melt extruder, whereby a polyolefin resin layer was formed. Hereinafter, the side at which the polyolefin resin layer was provided is referred to as “back side”.

### Preparation of Back Layer

62 parts of styrene as an aromatic ethylenic unsaturated monomer, 5 parts of glycidyl methacrylate as an ethylenic unsaturated monomer having an epoxy group, 3 parts of acrylic acid as an ethylenic unsaturated carboxylic acid monomer, and 30 parts of 2-ethylhexyl acrylate as an other ethylenic unsaturated monomer were subjected to emulsion polymerization in the presence of a reactive emulsifying agent (trade name: ADEKA REASOAP SE-10N, manufactured by Asahi Denka Kogyo Co., Ltd.), to obtain a water dispersion of a styrene-acrylic ester copolymer (component (A)). Separately, an isoprene-styrene-isoprene ABA block copolymer (isoprene/styrene/isoprene=40/20/40 (by weight), weight average molecular weight: 7500) was sulfonated, and neutralized with sodium hydroxide to form a dispersion of a water-insoluble resin in the form of a sodium salt (component (B)). 14 parts of the dispersion (component (A)) and 8 parts of the water-insoluble resin dispersion (component (B)) were mixed, and the solids concentration of the resultant mixture was adjusted to form a water dispersion having a solids concentration of 24%. A coating liquid for forming a back layer was prepared by mixing 10 parts of this water dispersion having a solids concentration of 24% and 1.92 parts of starch (HAMANOYUKI, trade name, manufactured by SHIN-SHIN FOODS Co., LTD.).

The polyolefin resin layer at the back side was subjected to corona discharge treatment, and, thereafter, the coating liquid for forming a back layer obtained was applied in a solids coating amount of 0.4 g/m², using an extrusion die coater. The coating liquid applied was dried at 70° C. to form a back layer.

Subsequently, a face at a side (hereinafter referred to as “front face”) opposite to a side at which the back layer was provided was subjected to corona discharge treatment, and then polyethylene having a density of 0.93 g/cm³ and including 10% by mass of titanium oxide was applied thereto in an amount of 24 g/m² by melt extrusion at a temperature of 320° C. using a melt extruder, whereby a polyolefin resin layer was formed.

### Preparation of Ink Receiving Layer Formation Liquid

According to the formulation of a silica dispersion liquid A described below, fumed silica particles were mixed with a liquid prepared by mixing dimethyldiallylammonium chloride polymer (trade name: SHALLOL DC-902P manufactured by Dai-ichi Kogyo Seiyaku Co., Ltd.) with ion-exchange water, and then zirconyl acetate was further added thereto. The resulting slurry was further subjected to dispersion treatment using an ULTIMIZER (trade name), manufactured by Sugino Machine Limited, under a pressure of 170 MPa, whereby a silica dispersion liquid A including silica particles having a median diameter (an average particle diameter) of 120 nm was prepared.

According to the formulation of an ink receiving layer formation liquid A described below, ion-exchange water, a 7.5% boric acid solution, a polycondensate of dimethylamine, epichlorohydrin and polyalkylene polyamine, a polyvinyl alcohol solution, and cation-modified polyurethane (cationic polymer) were sequentially added to the silica dispersion liquid A, followed by mixing, whereby an ink receiving layer formation liquid A was prepared.

Formulation of Silica Dispersion Liquid A

| | |
|---|---|
| (1) Fumed silica particles (AEROSIL (registered trademark) | 15.0 parts |
| 300SF75, manufactured by Nippon Aerosil Co., Ltd.) | |
| (2) Ion-exchange water | 82.9 parts |
| (3) Dimethyldiallylammonium chloride polymer (SHALLOL | 1.31 parts |
| DC-902P (51.5% solution), trade name, manufactured | |
| by Dai-ichi Kogyo Seiyaku Co., Ltd.) | |
| (4) Zirconyl acetate (50% solution), (tradename: ZIRCOSOL | 0.81 parts |
| ZA-30, manufactured by Daiichi Kigenso Kagaku | |
| Kogyo Co., Ltd.) | |

Formulation of Ink Receiving Layer Formation Liquid A

| | |
|---|---|
| (1) Silica dispersion liquid A | 59.5 parts |
| (2) Ion-exchange water | 7.8 parts |
| (3) 7.5% boric acid solution (crosslinking agent) | 4.4 parts |
| (4) Dimethylamine/epichlorohydrin/polyalkylene polyamine | 0.1 parts |
| polycondensate (50% solution), (trade name: | |
| SC-505, manufactured by Hymo Corporation) | |
| (5) Polyvinyl alcohol solution described below | 26.0 parts |
| (6) Cation-modified polyurethane (25% solution), | 2.2 parts |
| (trade name, SUPERFLEX 650-5, manufactured | |
| by Dai-Ichi Kogyo Seiyaku Co., Ltd.) | |

Formulation of Polyvinyl Alcohol Solution

| | |
|---|---|
| (1) Polyvinyl alcohol (trade name: JM-23, manufactured by | 6.96 parts |
| JAPAN VAM & POVAL Co., Ltd., having a saponification | |
| degree of 96.8 mol % and a polymerization degree of 2400) | |
| (2) Polyoxyethylene lauryl ether (surfactant; trade name: | 0.23 parts |
| EMULGEN 109P, manufactured by Kao Corporation) | |
| (3) Diethylene glycol monobutyl ether (trade name: | 2.12 parts |
| BUTYCENOL 20P, manufactured by Kyowa Hakko | |
| Chemical Co., Ltd.) | |
| (4) Ion-exchange water | 90.69 parts |

### Preparation of Inkjet Recording Sheet

The front face of the support was subjected to corona discharge treatment. Thereafter, the ink receiving layer formation liquid A described above and the in-line liquid 1 described below were blended in-line, and the blended liquid was applied onto the front face using an extrusion die coater such that the coating amount of the ink receiving layer formation liquid A was 183 g/m² and the coating amount of the in-line liquid 1 was 11.4 g/m². Thereafter, the resulting coating layer was dried at 80° C. using a hot air dryer (at an air flow rate of from 3 msec to 8 msec) until the solids concentration of the coating layer reached to 20%. During this period, the coating layer exhibited constant-rate drying. Further, before the coating layer exhibited falling-rate drying, the support having the coating layer was immersed in a basic solution (pH: 7.8) having the below-described formulation for three seconds such that the basic solution in an amount of 13 g/m² was applied onto the coating layer, and the coating layer was further dried at a temperature of 65° C. for 10 minutes (curing step). As a result, an inkjet recording medium 1 including an ink receiving layer with a dry layer thickness of 32 μm, and also including a back layer provided on the back side of the support, was prepared.

Formulation of In-Line Solution 1

| | |
|---|---|
| (1) Polyaluminum chloride aqueous solution having a basicity | 20 parts |
| of 83% (trade name: ALFINE 83, manufactured by TAIMEI | |
| CHEMICALS CO., LTD.) | |
| (2) Ion-exchange water | 80 parts |

Formulation of Basic solution

| | | |
|---|---|---|
| (1) | Boric acid | 0.65 parts |
| (2) | Ammonium carbonate (first grade) | 3.5 parts |
| | (manufactured by Kanto Chemicals Co., Inc) | |
| (3) | Ion-exchange water | 63.3 parts |
| (4) | Polyoxyethylene lauryl ether (surfactant, trade name: | 30.0 parts |
| | EMULGEN 109P, manufactured by | |
| | Kao Corporation, 2% solution) | |

### Example 2

An inkjet recording medium 2 was prepared in the same manner as in Example 1, except that the solids coating amount in the preparation of the back layer was changed to 0.05 g/m³ by diluting the coating liquid of Example 1.

### Example 3

An inkjet recording medium 3 was prepared in the same manner as in Example 1, except that the water-insoluble resin dispersion used in the preparation of the back layer in Example 1 was replaced with 8 parts of HYDRAN HW-350 (trade name, manufactured by Dainippon Ink and Chemicals Inc.; polyester-urethane having a solids concentration of 30%), and that the dispersion was diluted with water to have the same solids concentration as in Example 1.

### Example 4

An inkjet recording medium 4 was prepared in the same manner as in Example 1, except that the water-insoluble resin dispersion used in the preparation of the back layer in Example 1 was replaced with 5 parts of SN-307 (trade name, manufactured by NIPPON A & L Inc.; SBR having a solids concentration of 48%), and that the dispersion was diluted with water to have the same solids concentration as in Example 1.

### Example 5

An inkjet recording medium 5 was prepared in the same manner as in Example 1, except that the starch used in the preparation of the back layer in Example 1 was replaced with rice starch (trade name, manufactured by JAPAN CORN STARCH Co., LTD.).

### Comparative Example 1

An inkjet recording medium C1 was prepared in the same manner as in Example 1, except that the starch used in the preparation of the back layer in Example 1 was not added.

### Comparative Example 2

An inkjet recording medium C2 was prepared in the same manner as in Example 3, except that the starch used in the preparation of the back layer in Example 3 was not added.

### Comparative Example 3

An inkjet recording medium C3 was prepared in the same manner as in Example 4, except that the starch used in the preparation of the back layer in Example 4 was not added.

### Comparative Example 4

An inkjet recording medium C4 was prepared in the same manner as in Example 1, except that the starch used in the preparation of the back layer in Example 1 was changed to TECHPOLYMER MBX-40 (trade name, manufactured by SEKISUI PLASTICS CO., LTD.).

### Comparative Example 5

An inkjet recording medium C5 was prepared in the same manner as in Example 1, except that the starch used in the preparation of the back layer in Example 1 was replaced with SNOWTEX O (trade name, manufactured by NISSAN CHEMICAL INDUSTRIES, LTD.), and that the dispersion was diluted with water to have the same solids concentration as in Example 1.

<Evaluations>

The following evaluations were carried out on the inkjet recording media obtained above. The evaluation results are shown in the Table 1 below.

Here, the method for evaluating fog-like unevenness described below is an evaluation method which models an example of the state in which the ink receiving layer and the back layer rub each other during slit processing with a surface winding device.

Evaluation of Fog-Like Unevenness Caused by Adhesion of Polyolefin Resin

With respect to each of the inkjet recording media obtained above, two sheets thereof were superposed one on the other such that the ink receiving layer side of one sheet faced the back layer side of the other sheet. The sheets were rubbed with each other for a distance of 160 μm for 20 reciprocal strokes while applying a pressure of 0.14 MPa on average, whereby an evaluation sample was obtained.

A black solid image was printed on the ink receiving layer, of which the surface had been rubbed with the back layer, using an inkjet printer DL410 (trade name, manufactured by FUJIFILM CORPORATION) provided with a pure ink. Then, the image was observed with a microscope, and evaluated according to the following evaluation criteria.

Evaluation Criteria

A: The number of fog-like unevenness regions having a size of 100 μm or more and caused by adhesion of polyolefin resin is less than 10 per 25 cm², and fog-like unevenness is not clearly observed by visual observation.
B: The number of fog-like unevenness regions having a size of 100 μm or more and caused by adhesion of polyolefin resin is from 10 to less than 50 per 25 cm², and fog-like unevenness is slightly observable by visual observation.
C: The number of fog-like unevenness regions having a size of 100 μm or more and caused by adhesion of polyolefin resin is 50 or more per 25 cm², and the degree of the fog-like unevenness observed by visual observation is severe, which is practically problematic.

Evaluation of Fog-Like Unevenness Caused by an Imprint Generated by Applied Pressure

With respect to each of the inkjet recording media obtained in the Examples and the Comparative Examples described above, two sheets thereof were superposed one on the other such that the ink receiving layer side of one sheet faced the back layer side of the other sheet. A pressure of 0.2 MPa on average was applied thereto for 60 minutes, thereby obtaining an evaluation sample.

A black solid image was printed on the ink receiving layer, of which the surface had been pressed against the back layer, using an inkjet printer DL410 (trade name, manufactured by FUJIFILM CORPORATION) provided with a pure ink. Then the image was observed with a microscope, and evaluated according to the following evaluation criteria.

Evaluation Criteria

A: The number of fog-like unevenness regions having a size of 15 μm or more and caused by an imprint generated by applied pressure is less than 10 per 25 cm², and fog-like unevenness is not clearly observed by visual observation.
B: The number of fog-like unevenness regions having a size of 15 μm or more and caused by an imprint generated by applied pressure is from 10 to less than 50 per 25 cm², and fog-like unevenness is slightly observable by visual observation.
C: The number of fog-like unevenness regions having a size of 15 μm or more and caused by an imprint generated by applied pressure is 50 or more per 25 cm², and the degree of fog-like unevenness observed by visual observation is severe, which is practically problematic.

Evaluation of Curl Under High Humidity

Each of the A4-sized inkjet recording media obtained in the Examples and the Comparative Examples described above was stored for one day under an environment of 30° C. and 80% RH, and then the size of curl was measured and evaluated according to the following criteria.

Evaluation Criteria

A: The size of the curl is less than 3 mm at each of the four corners, which indicates satisfactory quality.
B: The size of the curl is from 3 mm to less than 10 mm at each of the four corners, which indicates somewhat impaired, but still acceptable quality.
C: The size of the curl is 10 mm or more at each of the four corners, which indicates clearly impaired, and practically intolerable quality.

TABLE 1

| | | | | | | | Evaluations | | |
|---|---|---|---|---|---|---|---|---|---|
| | Particles contained in back layer | | | | | | Fog-like unevenness | Fog-like unevenness | Curl |
| | | | Particle | | | Both | caused by adhesion | caused by imprint | under |
| | | Amount | diameter | | Coating | sides of | of polyolefin | generated by | high |
| | Kind | (g/m³) | (μm) | Binder | amount | support | resin | applied pressure | humidity |
| Example 1 | Starch | 0.18 | 10 | Acrylic | 0.4 | PE | A | A | A |
| | Particles | | | | | | | | |
| Example 2 | Starch | 0.02 | 10 | Acrylic | 0.05 | PE | B | B | A |
| | Particles | | | | | | | | |
| Example 3 | Starch | 0.18 | 10 | Urethane- | 0.4 | PE | B | A | A |
| | Particles | | | based | | | | | |
| Example 4 | Starch | 0.18 | 10 | SBR-based | 0.4 | PE | A | A | A |
| | Particles | | | | | | | | |
| Example 5 | Starch | 0.18 | 5 | Acrylic | 0.4 | PE | A | A | A |
| | Particles | | | | | | | | |
| Comparative | — | 0 | — | Acrylic | 0.4 | PE | C | C | A |
| Example 1 | | | | | | | | | |
| Comparative | — | 0 | — | Urethane- | 0.4 | PE | C | C | A |
| Example 2 | | | | based | | | | | |
| Comparative | — | 0 | — | SBR-based | 0.4 | PE | C | C | A |
| Example 3 | | | | | | | | | |
| Comparative | Organic | 0.18 | 40 | Acrylic | 0.4 | PE | C | C | A |
| Example 4 | Particles | | | | | | | | |
| Comparative | Colloidal | 0.18 | 0.015 | Acrylic | 0.4 | PE | C | C | A |
| Example 5 | Silica | | | | | | | | |

As is shown in Table 1, it is understood that, in the inkjet recording medium of the invention, generation of fog-like unevenness caused by adhesion of a polyolefin resin or fog-like unevenness caused by an imprint generated by applied pressure, which would otherwise occur during processing using a surface winding device, can be suppressed.

According to the invention, an inkjet recording medium having a polyolefin layer on each side of a base paper, in which generation of fog-like unevenness caused by adhesion of a polyolefin resin or fog-like unevenness caused by an imprint generated by applied pressure when processed with a surface winding device is suppressed, can be provided.

All publications, patent applications, and technical standards mentioned in this specification are herein incorporated by reference to the same extent as if each individual publication, patent application, or technical standard was specifically and individually indicated to be incorporated by reference.

What is claimed is:

1. An inkjet recording medium comprising:
a support which includes a base paper and a polyolefin resin layer provided on each side of the base paper;
an ink receiving layer that is provided on a side of the support, the ink receiving layer comprising inorganic particles and a water-soluble resin; and
a back layer that is provided on an opposite side of the support to the side on which the ink receiving layer is disposed, the back layer comprising starch particles.

2. The inkjet recording medium according to claim 1, wherein the starch particles have a number average particle diameter of from 1 μm to 30 μm.

3. The inkjet recording medium according to claim 1, wherein a content of the starch particles in the back layer is from 0.1 g/m² to 2 g/m².

4. The inkjet recording medium according to claim 1, wherein the back layer further comprises a resin.

5. The inkjet recording medium according to claim 1, wherein the polyolefin resin layer is a polyethylene resin layer.

6. The inkjet recording medium according to claim 1, wherein a thickness of the polyolefin resin layer is from 10 to 50 μm.

7. The inkjet recording medium according to claim 1, wherein a content ratio of the starch particles in the back layer is 20% by mass or higher.

8. The inkjet recording medium according to claim 4, wherein the resin contained in the back layer includes a water-insoluble resin having a number average molecular weight of from 300 to 1,000,000.

9. The inkjet recording according to claim 8, wherein a glass transition temperature (Tg) of the water-insoluble resin is from −10 to 50° C.

10. The inkjet recording medium according to claim 8, wherein the water-insoluble resin includes at least one of a urethane resin, an acrylic silicone resin, an acrylic styrene resin, a styrene-isoprene resin, or a styrene-butadiene resin.

11. The inkjet recording medium according to claim 8, wherein a content of the water-insoluble resin in the back layer is from 0.01 g/m² to 0.4 g/m².

12. The inkjet recording medium according to claim 8, wherein a mass ratio of the starch particles to the water-insoluble resin in the back layer is in a range of from 0.1 to 1.0.

13. The inkjet recording medium according to claim 1, wherein the inorganic particles are silica particles.

14. The inkjet recording medium according to claim 1, wherein an average primary particle diameter of the inorganic particles is 20 nm or less.

15. The inkjet recording medium according to claim 1, wherein the water-soluble resin comprises polyvinyl alcohol.
